(19) United States
(12) Patent Application Publication
(10) Pub. No.: US 2006/0161720 A1
(43) Pub. Date: Jul. 20, 2006

(54) Image data transmission method and system with DMAC

(75) Inventors: Feng Bai, Beijing (CN); David Xiao D. Yang, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/262,151

(22) Filed: Oct. 28, 2005

(30) Foreign Application Priority Data
Jan. 17, 2005 (CN) 200510002307.6

(51) Int. Cl. G06F 12/14; G06F 13/28; G06F 12/00

(52) U.S. Cl. 711/100

(57) ABSTRACT

Techniques for transmitting image data via the DMAC are disclosed. According to one aspect of the techniques, a DMA controller for an image data transmission system comprises a bus interface for receiving/transmitting data from/to a system bus; a request processing unit for processing a DMA request from a peripheral equipment and making a DMA response for the DMA request; a data, address, control register unit for storing data, address and control information from the bus interface; a macro block information register unit for storing macro block information of a macro block data which is pending for data transmission; and a control logic unit calculating continuous address ranges of the pending macro block data in a memory according to the macro block information so that corresponding continuous address data of the macro block is transmitted according to the continuous address ranges, respectively.

### BACKGROUND OF THE INVENTION

1. Field of the Invention

The present invention relates to the area of image data transmission, and more particularly to method and system for efficiently transmitting image data via DMAC with minimum impact on CPU.

2. Description of Related Art

A Direct Memory Access Controller (DMAC) has an advantage of high data transmission rate, so it is widely used in the fields where mass data requires to be transmitted. The DMAC has been used in an image data processing system to improve a data transmission efficiency of a whole system and guarantee real-time processing for the image. As shown in FIG. 1, a conventional DMAC includes a bus interface 101, a control logic unit 102, a request processing unit 103, a data, address and control register unit 104. With the four units, the DMAC transmits data from a source address to a destination address. However, the DMAC only can transmit data block with continuous addresses at one time, for those data blocks with non-continuous addresses, the DMAC has to transmit them in batches according to their respective continuous addresses.

In many applications, an image data processing system with a DMAC is mostly used to process static images or dynamic videos. The system stores sampling image data in frames in a memory. The system will transmit the image data from the memory to different image processing units via the DMAC. The different image processing units are provided, for example, to transform, enhance/restore, encode and segment the image data depending on a macro block, so the DMAC needs to change the image data in frames to the image data in macro blocks and transmits the macro block data to corresponding image processing units.

Referring to FIGS. 2a and 2b, the relationship between the frame and the macro block is described as following. Supposing that one frame image has m×n pixels, where the number of rows is m, the number of column is n, the start address of the image in the memory is 1, the start address of the macro block which requires to be transmitted is at the row i and the column j in the frame image, the macro block's size is 16×16, which means that the number of row and column of the macro block both are 16, the macro block in the frame image is the shielded area as shown in FIG. 2a. FIG. 2b is a diagram showing an address distribution of the frame of image in the memory, wherein the frame of image is stored according to the row information, and the macro block data is shown as the shielded area. It is apparent that the address of the macro block data in the memory is not continuous.

Because the frame image in the FIG. 2b is stored according to rows, each row data in the macro block is stored in the continuous address area, but the data of every two adjacent rows is not continuous, therefore the DMAC only can transmit one row data of the macro block at one time. It is should be noted that the frame image also can be stored according to columns, in which case each column data in the macro block is stored in the continuous address area but not two adjacent column data, the DMAC only can transmit one column data of the macro block at one time.

In an image processing operation, a system is configured to analyze redundant information between neighboring frame images which may occupy a lot of system resources due to an amount of image data required to be processed, the processing speed of a general CPU is slow and the power consumption is very large in this type of operation. Therefore, a motion estimation acceleration module is provided to accomplish all analysis about the required redundant information. When the image data process system is designed, a dedicated hardware module is often adapted to accomplish certain functions of the CPU. Because the data processing speed of the hardware module is a lot faster that that of the CPU, this kind of hardware module is called hardware accelerator. The hardware accelerator can process the image data in macro blocks, the DMAC is expected to transmit the image data from the memory to the hardware accelerator in macro blocks. To accomplish a macro block transmission, the following operations shall be conducted by the DMAC.

1. After receiving a data transmission request from the hardware accelerator, the DMAC makes a request for a bus control right from the CPU. When the CPU receives the request from the DMAC, the CPU configures the DMAC to transmit a first row data of the macro block. The configuration which the CPU makes for the DMAC includes that the CPU sends a control signal to the DMAC for starting the DMAC data transmission, transmits a start address of the first row and a data length to the DMAC via the system bus, and grants the bus control right to the DMAC.

2. After being granted the bus control right, the DMAC transmits the data of the first row to the hardware accelerator according to the start address of the first row data in the memory. In the transmission process of the first row data, the CPU can perform other tasks in the system.

3. After the first row data transmission is finished, the DMAC produces an interrupt request via the control logic unit and returns the bus control right back to the CPU.

4. The CPU responds to the interrupt request of the DMAC and configures the DMAC to transmit a second row data of the macro block. Repeating the corresponding operations until the macro block data transmission is accomplished by partitioning the macro block data into the sixteen segments.

It can be observed that the DMAC has to repeatedly interrupt the CPU's execution on other tasks to get the continuation address in the macro block in the macro block data transmission. However frequently interrupting CPU's program execution will add additional burdens to the system operation and lead the bus to conflict within the system, thus the data transmission rate is reduced.

Thus there is a need for techniques for transmitting image data more efficiently via the DMAC with minimum impact on the resources of a CPU.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to techniques for transmitting image data via the DMAC. According to one aspect of the techniques, a DMA controller is provided. The DMAC includes a request processing unit for processing a DMA request from a peripheral equipment and making a DMA response for the DMA request; a data, address, control register unit for storing data, address and control information from the bus interface; a macro block information register unit for storing macro block information of a macro block data which is pending for data transmission; and a control logic unit calculating continuous address ranges of the pending macro block data in a memory according to the macro block information so that data of the macro block is transmitted repeatedly according to the continuous address ranges, respectively.

The present invention may be implemented in hardware and software as a system, an apparatus or a method. According to one embodiment, the present invention is an image data transmission system, the system comprises a source memory providing macro block data of frame image required to be transmitted; a destination unit receiving the macro block data of the frame image; a CPU providing a macro block information of the macro block; and a DMAC receiving the macro block information. The DMAC transmits continuous address data of the macro block in the memory according to the macro information in batches.

According to another embodiment, the present invention is a method, the method comprises transmitting a macro block information of a macro block in the frame image to the DMAC by the CPU; calculating continuous address ranges of the macro block according to the macro block information; and transmitting continuous address data of the macro block according to corresponding continuous address ranges.

One of the features, benefits and advantages in the present invention is to provide techniques for transmitting a block of image data from a frame of image without interrupting a central processor.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram showing a convention DMAC;

FIG. 2a is a schematic diagram showing a frame image stored in a memory with plural macro blocks;

FIG. 2b is a schematic diagram showing address distribution of the frame image data and the macro image data in the memory;

FIG. 3 is a schematic diagram showing a DMAC of the present invention;

FIG. 4 is a schematic diagram showing an image data transmission system with the DMAC shown in FIG. 3; and

FIG. 5 is a flow chart showing an operation procedure of transmitting the macro block data via the DMAC.

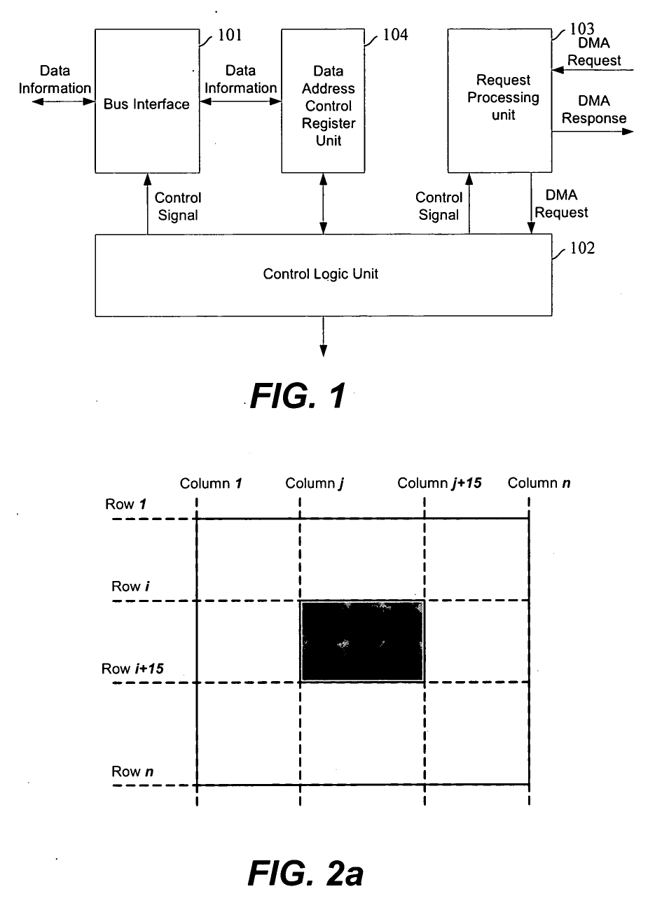

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

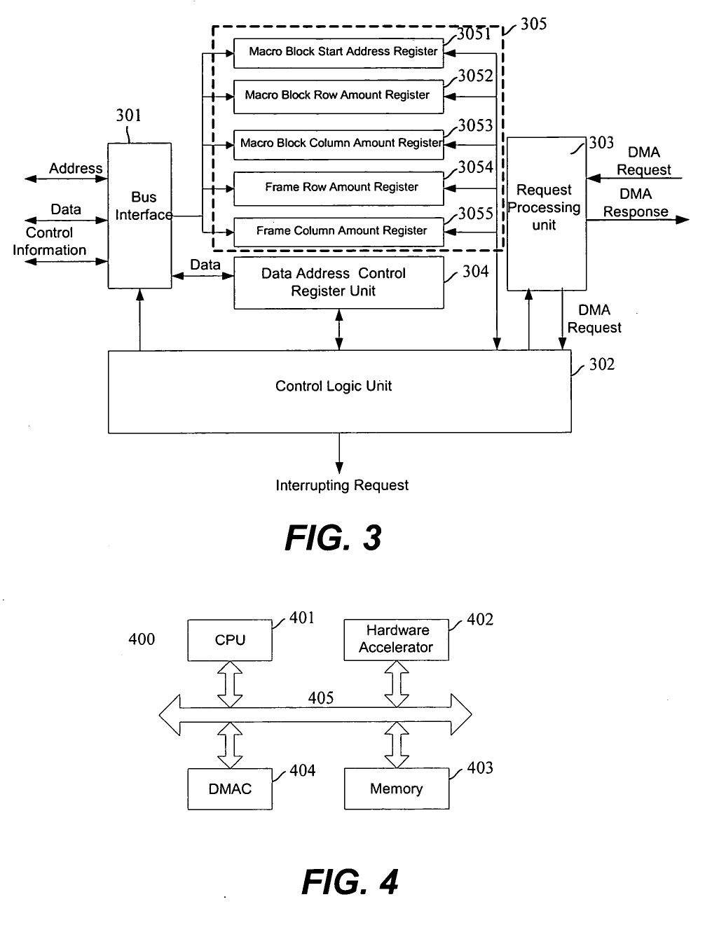

As shown in FIG. 3, according to one embodiment of the present invention, a DMAC, which may be adapted for an image data transmission system, includes a bus interface 301, a control logic unit 302, a request processing unit 303, a data, address; control register unit 304 and a macro block information register unit 305.

The bus interface 301 is in charge of receiving/transmitting data or information from/to a system bus and managing a sequential logic of a bus in a system. The data, address and control information from a processor (e.g., a CPU, not shown) for the DMAC is transmitted to the data, address and control register unit 304 via the bus interface 301, while the data, address and control register unit 304 sends the data, address and control information via the bus interface 301 to the processor of the system as well.

The control logic unit 302 is provided for reading the control information from the data, address and control register unit 304, receiving a DMA request from the request processing unit 303, controlling operations of the bus interface 301, the request processing unit 303, the data, address and control register unit 304 via control signals, and producing an interrupting request. The request processing unit 303 is configured to process a DMA request from a peripheral processing equipment such as a hardware accelerator and making a DMA response for the DMA request.

The data, address and control register unit 304 includes three kinds of registers: a data register, an address register and a control register. The address register stores a source address and a destination address in a data transmission by the DMAC. The data register is used to temporarily store data retrieved from a source address, and write the data to a destination address. The control register stores a control signal and DMA status information. According to one embodiment, three kinds of registers are adapted to realize the data exchange.

In one embodiment, the macro block information register unit 305 includes a macro block start address register 3051, a macro block row amount register 3052, a macro block column amount register 3053, a frame row amount register 3054 and a frame column amount register 3055. The registers are respectively used to store a start address, row and column amounts of a macro block which is pending for transmission, row and column amounts of a frame which the pending macro block belongs to. In one embodiment, a part or whole of these five data such as the start address, the row and column amount of the macro block, the row and column amount of the frame are called macro block information.

The macro block information register unit 305 gets the macro block information from the bus interface 301 and sends the macro block information to the control logic unit 302 for calculating addresses of each row or each column of the macro block. In other words, the control logic unit 302 is configured to calculate continuous address ranges of the macro block. The operations of the macro block information register unit 305 are controlled by the control logic unit 302.

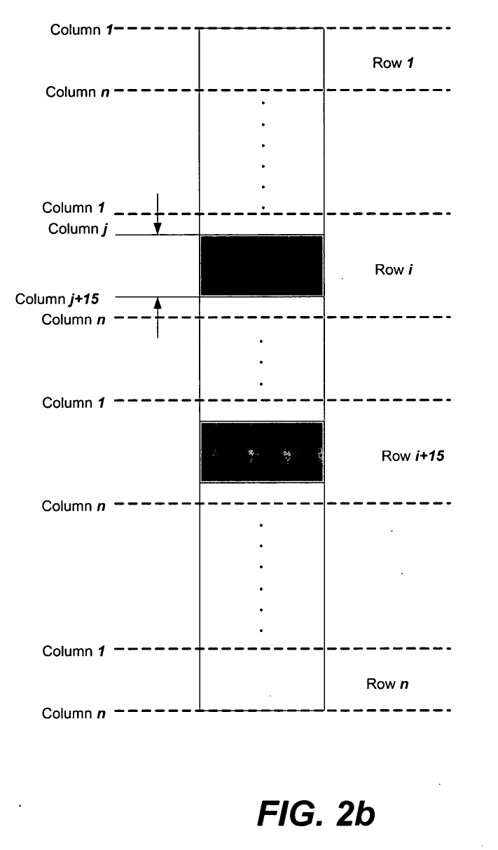

Referring to the frame image data and the macro block data shown in FIGS. 2a and 2b, the operations of how the control logic unit 302 calculates the continuous address of a macro block are described. As shown in FIG. 2(a), supposing that one frame image has m×n pixels, wherein the row amount is m, the column amount is n; the start address of the frame image in the memory is 1, the macro block which needs to be transmitted is in the row i and the column j in the frame image, wherein its size is 16×16, therefore the start address of the macro block is the (i−1)n+j.

The control logic unit 302 reads the start address of a first row data of the macro block from the macro blocks start address register 3051, and determines the continuous address range of the first row data of the macro block according to the following formula:

[(i+k−2)n+j,(i+k−2)n+j+15] (1)

wherein k represents the number of rows and is set to 1. Therefore, the address range of the first row data of the macro block is [(i−1)n+j,(i−1)n+j+15].

In the same way, the control logic unit 302 calculates the continuous address range of the k row data of the macro block according formula (1), wherein k is 2, 3 . . . 16, respectively.

It can be appreciated that, if the frame image is stored in columns, the continuous address ranges of the macro block data can be calculated by the similar ways.

According to one embodiment, one or more registers in the macro block information register unit 305 are omitted according to a storing format of the frame image in the memory. For example, when the frame image is stored in rows, the macro block information register unit 305 includes the registers 3051, 3052, 3053, and 3055, and the register 3054 is omitted, when the frame image is stored in columns, the macro block information register unit 305 comprises the registers 3051, 3052, 3053, and 3054, and the register 3055 is omitted. In any case, it should be understood that registers 3051˜3055 shown in FIG. 3 are not necessarily individual registers, nor a single register. Depending on an actual implementation, various combinations are possible.

In reference to the DMAC of FIG. 3, an image data transmission system 400 is provided and shown in FIG. 4. The image data transmission system includes a CPU 401, a hardware accelerator 402, a memory 403 and a Direct Memory Access Controller (DMAC) 404 the detail of which is shown in FIG. 3. The four units receive and send data via a system bus 405.

When the image data transmission system carries out image data transmission depending on macro blocks, at first, the CPU 401 sends macro block information of a macro block which is pending for transmission to the DMAC 404 via the system bus 405.

The macro block information includes the macro block start address, the macro block row number, the macro block column number, the frame row number and the frame column number, which are respectively stored in the macro block start address register, the macro block row amount register, the macro block column amount register, the frame image row amount register and the frame image column amount register provided in the DMAC 404.

The DMAC 404 calculates continuous address ranges of the macro block according to the macro block information, and transmits the macro block data in the memory 403 to the hardware accelerator 402 according to the continuous address ranges of the macro block.

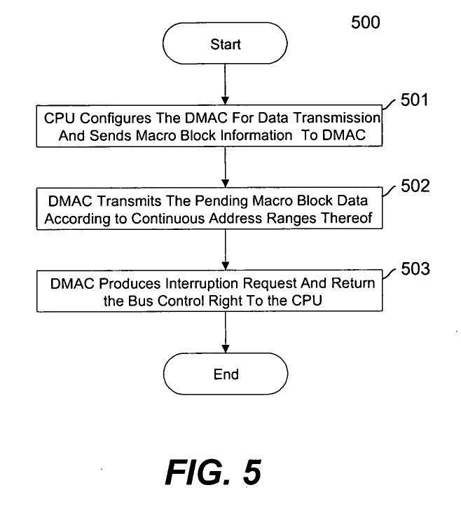

Referring now to FIG. 5, there shows a flowchart or process 500 according to one embodiment of the present invention. The process 500 may be implemented in software and hardware as a system, an apparatus or a part of a chip. Although it is suggested that the process 500 be readily understood in conjunction with FIG. 3 or FIG. 4, those skilled in the art that such relationship does not imply any inherent limits of the present invention.

At 501, when a DMAC (e.g., 404 of FIG. 4) receives a data transmission request from a hardware accelerator 402, it asks the CPU 401 for a bus control right. After receiving the DMAC request, the CPU 401 configures the DMAC 404 for data transmission and sends macro block information of a macro block in a frame image which is pending for transmission to the DMAC via the system bus. The CPU sends a control signal to the DMAC, as a response, grants the bus control right to the DMAC for starting the DMAC data transmission.

In one embodiment, the macro block information from the CPU 401 to the DMAC 404 includes a macro block start address, a macro blocks row number, a macro blocks column number, a frame row number and a frame column number.

According to the storing format of the frame image in the memory 403, the CPU only needs to send a part of the macro block start address, the macro block row and column number, the frame row and column numbers to the DMAC. As described above, the DMAC needs to be equipped with only necessary registers. For example, when the frame image is stored in columns, the CPU only need to send the macro block start address, the macro block row and column number, the frame row number to the DMAC, so only corresponding registers are needed in the DMAC. Likewise, when the frame image is stored in rows, the macro block start address, the macro block row and column number, the frame column number need to be sent to the DMAC.

At 502, while the DMAC transmits the pending macro block data according to continuous address ranges of the macro block, the CPU can process other programs generated by the system. According to the image data transmission system shown in FIG. 4, it is supposed that the frame image is stored in rows, and each row data is stored in a continuous address. To transmit the macro block data, the following operations are preformed:

At first, the control logic unit 302 of the DMAC calculates the continuous address range of a first row of the macro block according to the macro block start address and the macro block column amount.

Secondly, according the continuous address range address of the first row data of the macro block, the DMAC fetches out the first row data of the macro block and transmits the first row data to the hard ware accelerator 402. Then, the DMAC 404 calculates the continuous address range of No. k row of the macro block, and transmits the No. k row data to the hard ware accelerator until a last row of the macro block is encountered, wherein k is 2, 3, . . . , 16, respectively.

At 503, the DMAC produces an interruption request and return the bus control right to the CPU when this macro block data transmission has completed. Due to the macro block information provided in the DMAC, it reduces considerably demanding responses from the CPU during the macro block transmission, thus decreasing the system operation load so that the data transmission rate is accelerated.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

What is claimed is:

1. A DMA controller for an image data transmission system, the DMA controller comprising:
a bus interface for receiving/transmitting data from/to a system bus;
a control logic unit;
a request processing unit, coupled to the control logic unit, for processing a DMA request from a peripheral equipment and making a DMA response for the DMA request;
a data, address, control register unit, also coupled to the control logic unit, for storing data, address and control information from the bus interface;
a macro block information register unit for storing macro block information of macro block data which is pending for data transmission; and
a control logic unit, coupled to the bus interface, configured to calculate continuous address ranges of the pending macro block data in a memory according to the macro block information so that corresponding continuous address data of the macro block is transmitted according to the continuous address ranges, respectively.

2. The DMA controller as claimed in claim 1, wherein the macro block information register unit comprises a register for storing a start address of the macro block in the memory, a register for storing a row number of the macro block, a register for storing a column number of the macro block, a register for storing a row number of a frame image which the pending macro block belongs to, or a register for storing a column number of the frame image.

3. The DMA controller as claimed in claim 1, wherein when a frame image which the macro block belongs to is stored according to rows, each row data of the macro block has a continuous address in the memory, the control logic unit calculates the continuous address range of each row data of the macro block according to the macro information.

4. The DMA controller as claimed in claim 1, wherein when the frame image which the macro block belongs to is stored according to columns, each column data of the macro block has a continuation address in the memory, the control logic unit calculates the continuous address range of each column data of the macro block according to the macro block information.

5. The DMA controller as claimed in claim 1, wherein the macro information is sent to the macro block information register unit by the interface bus.

6. An image data transmission system, comprising:
a source memory providing macro block data of frame image required to be transmitted;
a destination unit receiving the macro block data of the frame image;
a CPU providing a macro block information of the macro block; and
a DMAC receiving the macro block information, wherein the DMAC transmits continuous address data of the macro block in the memory according to the macro information in batches.

7. The image data transmission system as claimed in claim 6, wherein before transferring the continuous address data of the macro block, the DMAC calculates continuous address ranges of the macro block data in the memory according to the macro information.

8. The image data transmission system as claimed in claim 6, wherein the DMAC is provided with a register unit for storing the macro information.

9. The image data transmission system as claimed in claim 8, wherein the register unit comprises a register for storing a start address of the macro block in the memory, a register for storing a row amount of the macro block, a register for storing a column amount of the macro block, a register for storing a row amount of a frame image which the pending macro block belongs to and/or a register for storing a column amount of the frame image.

10. The image data transmission system as claimed in claim 7, wherein when the frame image is stored according to rows in the memory, each row data of the macro block has a continuous address in the memory, the DMAC calculates the continuous address range of each row data of the macro block according to the macro information.

11. The image data transmission system as claimed in claim 7, wherein when the frame image is stored according to columns in the memory, each column data of the macro block has a continuation address in the memory, the DMAC calculates the continuous address range of each column data of the macro block according to the macro block information.

12. A method for providing an image data transmission, the method comprising:
storing frame image data required to be transmitted,
transmitting a macro block information of a macro block in the frame image to the DMAC by a CPU;
calculating continuous address ranges of the macro block in the DMAC according to the macro block information; and
transmitting data of the macro block continuously according to each of the continuous address ranges without interrupting the CPU.
